(19) United States
(12) Patent Application Publication
(10) Pub. No.: US 2024/0419786 A1
(43) Pub. Date: Dec. 19, 2024

(54) IDENTIFYING POINTS OF INTEGRATION IN COMPUTING INFRASTRUCTURE USING RECONNAISSANCE TECHNIQUES

(71) Applicant: Noname Gate Ltd., Tel Aviv-Yafo (IL)

(72) Inventors: Dor DANKNER, Tel Aviv (IL); Ofir MANZUR, Tel Aviv-Yafo (IL); Haviv VAIZMAN, Pardes Hanna-Karkur (IL); Samuel ELGOZI, Gan Yavne (IL)

(73) Assignee: Noname Gate Ltd., Tel Aviv-Yafo (IL)

(21) Appl. No.: 18/333,985

(22) Filed: Jun. 13, 2023

(51) Int. Cl. G06F 21/55

(52) U.S. Cl. CPC G06F 21/552

(57) ABSTRACT

A system and method for securing a computing infrastructure. A method includes performing reconnaissance with respect to a computing infrastructure in order to identify a plurality of portions of the computing infrastructure and a plurality of components of the computing infrastructure; correlating the plurality of portions of the computing infrastructure with the plurality of components of the computing infrastructure; identifying an integration point among the computing infrastructure based on the correlation, wherein the integration point is one of the plurality of components of the computing infrastructure through which the computing infrastructure is integrable; and performing at least one mitigation action based on the identified integration point.

### TECHNICAL FIELD

The present disclosure relates generally to cybersecurity for computing interfaces, and more specifically to identifying potential points of exposure which may be utilized to secure computing interfaces against potential cyber threats.

### BACKGROUND

The vast majority of cybersecurity breaches can be traced back to an issue with a computer interface such as an application programming interface (API). API abuses are expected to become the most frequent attack vector in the future, and insecure APIs have been identified as a significant threat to cloud computing.

An API is a computing interface. A computing interface is a shared boundary across which two or more separate components of a computer system exchange information. Computing interfaces therefore allow disparate computing components to effectively communicate with each other despite potential differences in communication format, content, and the like. An API defines interactions between software components.

A significant challenge facing research and development (R&D) teams utilizing computing interfaces to facilitate interactions with external services is that, for practical purposes, there is an unlimited amount of potential work to be performed in securing a computing infrastructure, particularly as that infrastructure changes rapidly. It is therefore unfeasible for R&D teams to manually address all potential exploits, and prioritization is necessary. However, many developers lack full visibility into the resources used within their infrastructures and how those resources are connected, particularly when connected via computing interfaces, which makes prioritizing cybersecurity analysis difficult. This issue is further challenging for companies that utilize multiple cloud services providers.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for securing a computing infrastructure. The method comprises: performing reconnaissance with respect to a computing infrastructure in order to identify a plurality of portions of the computing infrastructure and a plurality of components of the computing infrastructure; correlating the plurality of portions of the computing infrastructure with the plurality of components of the computing infrastructure; identifying an integration point among the computing infrastructure based on the correlation, wherein the integration point is one of the plurality of components of the computing infrastructure through which the computing infrastructure is integrable; and performing at least one mitigation action based on the identified integration point.

Certain embodiments disclosed herein also include a non-transitory computer readable medium having stored thereon causing a processing circuitry to execute a process, the process comprising: performing reconnaissance with respect to a computing infrastructure in order to identify a plurality of portions of the computing infrastructure and a plurality of components of the computing infrastructure; correlating the plurality of portions of the computing infrastructure with the plurality of components of the computing infrastructure; identifying an integration point among the computing infrastructure based on the correlation, wherein the integration point is one of the plurality of components of the computing infrastructure through which the computing infrastructure is integrable; and performing at least one mitigation action based on the identified integration point.

Certain embodiments disclosed herein also include a system for securing a computing infrastructure. The system comprises: a processing circuitry; and a memory, the memory containing instructions that, when executed by the processing circuitry, configure the system to: perform reconnaissance with respect to a computing infrastructure in order to identify a plurality of portions of the computing infrastructure and a plurality of components of the computing infrastructure; correlate the plurality of portions of the computing infrastructure with the plurality of components of the computing infrastructure; identify an integration point among the computing infrastructure based on the correlation, wherein the integration point is one of the plurality of components of the computing infrastructure through which the computing infrastructure is integrable; and perform at least one mitigation action based on the identified integration point.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for mitigating potential cyber threats using correlations between reconnaissance results and computing infrastructure according to an embodiment.

FIG. 3 is a flowchart illustrating a method for performing reconnaissance with respect to computing resources according to an embodiment.

FIG. 4 is a flowchart illustrating a method for identifying integration points among a computing infrastructure according to an embodiment.

FIG. 5 is a flowchart illustrating a method for proposing integration points for a computing infrastructure using reconnaissance techniques according to an embodiment.

FIG. 6 is a flowchart illustrating a method for prioritizing development for a computing infrastructure using reconnaissance techniques according to an embodiment.

FIG. 7 is a schematic diagram of an integration scout according to an embodiment.

### DETAILED DESCRIPTION

In light of the challenges noted above, it has been identified that reconnaissance techniques akin to the techniques which may be utilized by malicious attackers can be leveraged in order to gain visibility into computing infrastructure. More specifically, it has been identified that information gathered using such reconnaissance techniques may be utilized to identify points of integration which may be exploited during a cyberattack. Further, it has been identified that those points of integrations may be leveraged in order to secure computing infrastructure against potential cyber threats.

To this end, the disclosed embodiments include methods and systems for securing computing infrastructure using reconnaissance techniques. The disclosed embodiments utilize the results of reconnaissance in order to identify potential integration points among computing infrastructures, which in turn may be used in order to secure the computing infrastructures. In particular, data collected during reconnaissance is correlated to components of computing infrastructure in order to identify certain components of the computing infrastructure as potential points of integration (also referred to herein as integration points). In various embodiments, data related to a computing infrastructure (e.g., data indicating a domain in which components of the computing infrastructure are located) is used in order to perform the reconnaissance techniques.

To support the correlation between reconnaissance results and computing infrastructure, some disclosed embodiments further provide techniques for mapping computing resources among the computing infrastructure. The mapping may be utilized to identify potential points of integration, to prioritize work being performed on the computing infrastructure, both, and the like. As a non-limiting example for prioritizing work being performed on the infrastructure, the mapping may be utilized to determine that about 20% of the computing infrastructure uses resources of a first cloud provider and that about 5% of the computing infrastructure uses resources of a second cloud provider. Based on such a determination, work being performed with respect to the use of the resources of the first cloud provider may be prioritized over work related to the second cloud provider.

The mapping may be utilized in order to identify points of integration, and may also be utilized to prioritize computing resources used to secure resources represented in the mapping. As a non-limiting example, the mapping may be utilized to generate statistics regarding resource usage defined with respect to which computing infrastructures are being used more than others, which in turn may be utilized to prioritize cybersecurity tools configured for automated responses (e.g., to prioritize alerts indicating computing infrastructures which have a higher percentage of the mapped resources over alerts indicating computing infrastructures which have lower percentages of mapped resources).

In addition to the cybersecurity benefits discussed herein, the disclosed embodiments may further provide benefits related to planning and development of computing infrastructure. As a non-limiting example, using the reconnaissance techniques described herein to identify potential integration points allows for determining appropriate locations at which operators of a computing infrastructure may deploy integrations, thereby significantly reducing the time needed to perform evaluation of the computing infrastructure, for example the time needed to perform a proof of value (PoV) step.

As another non-limiting example of how various disclosed techniques may be utilized to improve planning and development, maps created as described herein may be or may include various domain addresses of one or more computing infrastructures. The mapped domain addresses may be analyzed to determine which computing infrastructure is used by each domain address, which in turn may be utilized for purposes such as generating statistics regarding resource usage defined with respect to which computing infrastructures are being used more than others. Such statistics may be utilized for prioritization of development resources, for example, by generating notifications indicating the percentage of resources belonging to each computing infrastructure represented in the mapping such that a development team can focus their efforts on the computing infrastructures having the highest percentages of resources being used.

Moreover, various disclosed embodiments may enable new possibilities with regard to integration discovery and planning. In some implementations, the reconnaissance techniques may utilize as little information as a single domain in order to map the computing infrastructure and identify potential points of integration. For example, reconnaissance techniques utilizing Secure Sockets Layer (SSL) certificate signatures, Domain Name System (DNS) information, website icon hashes, and word similarities between domain names may be utilized individually or in combination in order to proliferate the potential domains related to the computing infrastructure using a single domain.

These results provide much easier and more accurate discovery than existing solutions, which often require many examples of computing interface calls to be manually created by a user (e.g., when there is insufficient traffic or time to collect traffic data) or otherwise require an exhaustive list of domains or integration points of the computing infrastructure. Manually creating such computing interface calls or listing out all domains may be a cumbersome process and is subject to human error, i.e., if the examples are wrong (e.g., due to typos or misunderstandings), then the discovery process will miss potential points of integration and may otherwise have an incomplete mapping of the computing infrastructure. The disclosed embodiments, at least some of which do not require these kinds of details in the first place, provide more accurate analysis with less work creating inputs than such existing solutions. Moreover, various disclosed embodiments can be performed without requiring credentials for accessing components of the computing infrastructure, thereby further reducing the amount of inputs needed and potential errors which could come from inaccurate or incomplete inputs.

Even further, various disclosed embodiments can significantly increase the speed of discovery and therefore reduce the amount of time it takes to identify potential points of integration. More specifically, various disclosed embodiments can be realized without requiring user inputs after the initial inputs, and can find potential issues with points of integration in as little as a few hours. Also, the disclosed embodiments may be performed based on limited inputs from a single user or otherwise a single unit within an organization, and without requiring coordinating integration among multiple units of the organization.

Moreover, the disclosed embodiments can be performed using a significantly lower amount of traffic than several existing solutions, as a non-limiting example, traffic collected over a few hours as opposed to traffic collected over a week or more. This further improves the speed and can decrease the amount of traffic data which must be processed to perform discovery, thereby conserving computing resources.

The above advantages further translate to decreased time required for demonstrating proof of value (PoV) for the computing infrastructure. Additionally, the disclosed embodiments can be utilized to identify potential cybersecurity vulnerabilities based on the identified integration points. As a non-limiting example, it may be determined that secrets are being saved on a front end of a service when the secrets should only be saved on the back end according to one or more rules defining security protocols for saving secrets. As other non-limiting examples, the integration points identified as described herein may be utilized to perform anomaly detection and posture management based on respective sets of rules, traffic behaviors, or both, in order to identify current or potential vulnerabilities in the computing infrastructure and to avoid or otherwise mitigate cyber threats which may exploit those vulnerabilities.

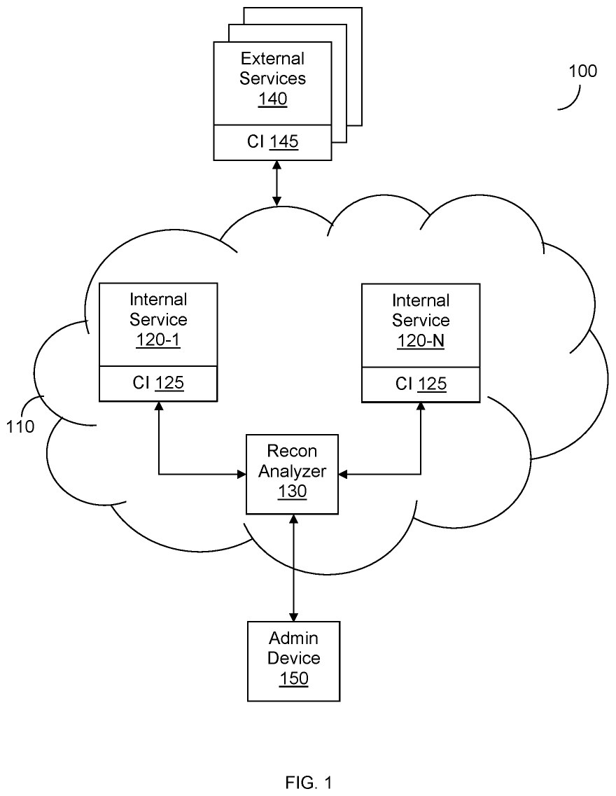

FIG. 1 shows an example network diagram 100 utilized to describe the various disclosed embodiments. In the example network diagram 100, internal services 120-1 through 120-N (which may be referred to individually as an internal service 120 or collectively as internal services 120) communicate with each other and/or with one or more external services 140 (which may be referred to individually as an external service 140 or collectively as external services 140). The internal services 120 are services hosted on a network 110. Each of the internal services 120 communicates at least using a respective communications interface (CI) 125 and each of the external services 140 communicates at least using a respective communications interface (CI) 145. The computing interfaces 125 and 145 may be, but are not limited to, Application Programming Interfaces (APIs).

The network 110 may be, but is not limited to, a wireless, cellular or wired network, a local area network (LAN), a wide area network (WAN), a metro area network (MAN), the Internet, the worldwide web (WWW), similar networks, and any combination thereof. The network 110 may be operated by an organization (e.g., by including servers owned by the organization), or may be operated by another entity (e.g., a cloud provider or other provider of network computing services). It should be noted that a single network 110 is depicted merely for simplicity purposes, but that the internal services 120 may communicate via multiple networks and/or other connections in accordance with the disclosed embodiments.

The reconnaissance (recon) analyzer 130 is configured to perform reconnaissance processes in order to identify integration points as described herein. To this end, the recon analyzer 130 may be configured to perform mapping of a computing infrastructure of the network 110, including portions of the network infrastructure related to interactions with the external services 140. The recon analyzer 130 may also be configured to perform processes related to prioritizing research and development (R&D) activities as described herein.

In accordance with various disclosed embodiments, the recon analyzer 130 may receive, for example from an administrator (admin) device 150, data related to one or more locations in the computing infrastructure (e.g., data indicating a domain such as “company.com”). The reconnaissance processes may be performed based on such data.

The results of any or all of the processes performed by the recon analyzer 130 may be used to generate and send notifications or other data to the admin device 150. The admin device 150 may be operated by an administrator of the network 110, a software engineer, or any other person involved in R&D. To this end, the admin device 150 may be, but is not limited to, a personal computer, a laptop, a tablet computer, a smartphone, a wearable computing device, or any other device capable of receiving and displaying notifications.

It should be noted that the particular network configuration shown in FIG. 1 is merely utilized to illustrate an example deployment of the recon analyzer 130, and that the disclosed embodiments may be applied to other network configurations without departing from the scope of the disclosure. As some particular examples, different numbers of internal services 120 may communicate within the network 110, and the network configuration analyzer 130 may be configured to detect vulnerabilities related to computing interfaces served or consumed by any or all of them. In some implementations, multiple network configuration analyzers may be utilized. Additionally, the recon analyzer 130 may be implemented as a system (e.g., a server), as a virtual machine, as a software container or other self-contained software package, and the like.

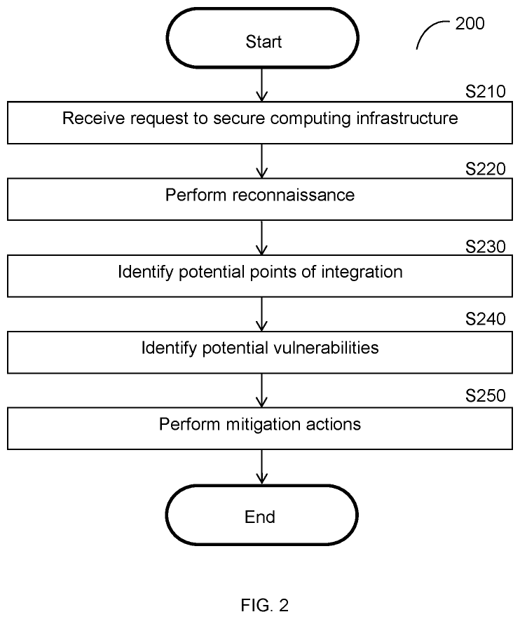

FIG. 2 is a flowchart 200 illustrating a method for mitigating potential cyber threats using correlations between reconnaissance results and computing infrastructure according to an embodiment. In an embodiment, the method is performed by the recon analyzer 130, FIG. 1.

At S210, a request to secure a computing infrastructure is received. The request may be received, for example, from the user device 120, FIG. 1. In an embodiment, the request includes one or more domain addresses, each of which identifies a system among the computing infrastructure to be secured. Such domain addresses may be, but are not limited to, Internet Protocol (IP) addresses, domain names, and the like.

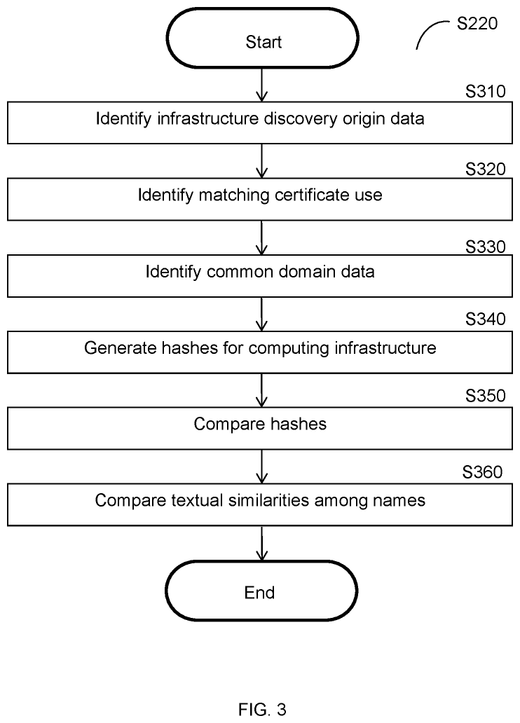

At S220, one or more reconnaissance techniques are performed. The reconnaissance techniques are performed in order to obtain one or more types of data which an attacker might attempt to retrieve in a cybersecurity attack. Such types of data may include, but are not limited to, credentials, source code, domain registration data, and the like. To this end, S220 may include performing any of identifying use of SSL certificate signatures, identifying other domains containing common DNS information, identifying users or assignees of network resources (e.g., a user or assignee of an Internet resource such as a domain name or Internet Protocol address block) comparing hashes of icons, comparing word similarities between domain names, combinations thereof, and the like. In an embodiment, the reconnaissance techniques may be performed as described further below with respect to FIG. 3.

At S230, potential points of integration are determined based on the results of the reconnaissance performed at S220. In an embodiment, S230 includes correlating between results of the reconnaissance and components of the computing infrastructure to identify one or more of those components as potential points of integration.

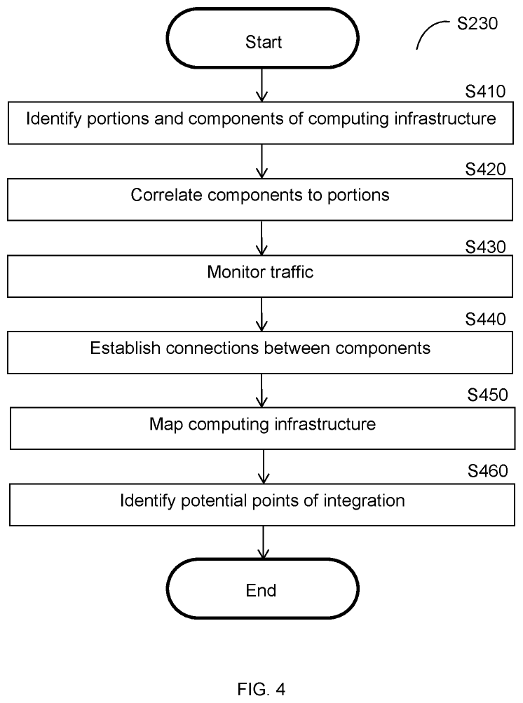

In an embodiment, the potential points of integration are identified as described further below with respect to FIG. 4. In such an embodiment, identifying the potential points of integration may further include mapping the computing infrastructure.

At S240, potential vulnerabilities are identified based on the potential points of integration. In an embodiment, S240 includes applying one or more predetermined integration point vulnerability identification rules. Such rules may define required configurations, deployments, parameters, or other circumstances with respect to different locations in the infrastructure, types of components, combinations thereof, and the like. In a further embodiment, an integration point represented by a component with a configuration, deployment, set of parameters, or combination thereof, which does not meet the required circumstances may be identified as a potential vulnerability. In yet a further embodiment, when the components of the computing infrastructure include computing interfaces, which integration point vulnerability identification rules to be applied may be determined based on respective types of those computing interfaces (e.g., types determined as discussed herein), or otherwise the integration point vulnerability identification rules may be applied based on the types of computing interfaces acting as potential integration points for which vulnerabilities are to be identified.

In some embodiments, the potential vulnerabilities may be identified based further on behavior of components which are or are connected to potential points of integration. As a non-limiting example, a potential vulnerability may include a behavior including saving secrets on a front end of an application that should only be saved on the back end (where secrets being required to be saved only on the back end rather than the front end are defined as part of the integration point vulnerability identification rules).

At S250, one or more mitigation actions may be performed based on the potential vulnerabilities. The mitigation actions are performed in order to secure the computing infrastructure against potential exposure and may include, but are not limited to, blocking traffic to and from locations with potential vulnerabilities, reconfiguring components with respect to the potential vulnerabilities, generating a notification including a recommendation to reconfigure components with respect to the potential vulnerabilities or otherwise indicating the potential vulnerabilities, combinations thereof, and the like.

FIG. 3 is a flowchart S220 illustrating a method for performing reconnaissance with respect to computing resources according to an embodiment.

Various steps illustrated in FIG. 3 are depicted in a particular order for simplicity purposes, but it should be noted that any or all of these steps may be performed in a different order without departing from the scope of the disclosure. Moreover, at least some of the steps may be performed in parallel to each other without departing from the scope of the disclosure.

At S310, infrastructure discovery origin data to be used for conducting the reconnaissance techniques is identified. Such data may include, but is not limited to, data received as part of a request to secure a computing infrastructure. In an embodiment, the infrastructure discovery origin data includes, but is not limited to, data indicating a domain belonging to or otherwise associated with a computing infrastructure such as a domain address of a domain of the computing infrastructure.

In a further embodiment, such data only includes domain data. In yet a further embodiment, such data only includes a single domain address. As noted above, the disclosed embodiments may be utilized to accurately and comprehensively identify various potential points of integration within an infrastructure while using only limited information about the infrastructure.

At S320, one or more uses of matching certificates are identified. The identified uses may include, but are not limited to, uses of certificates which match a certificate associated with one or more computing infrastructure resources deployed in a first domain (e.g., a domain indicated in the data identified at S310) which match certificates being utilized for computing infrastructure resources in other domains. As a non-limiting example, S320 may include finding different websites or other resources which use the same Secure Sockets Layer (SSL) certificate.

In an embodiment, S320 may include connecting to a certificates repository storing data indicating certificates associated with respective network resources (e.g., SSL certificates associated with respective websites), and identifying one or more of those certificates which match one or more certificates of the computing infrastructure.

At S330, common domain data is identified. Such domain data may include, but is not limited to, email addresses, company names, and the like. As a non-limiting example, an email address may be identified by a domain of the computing infrastructure (e.g., a domain indicated in the data identified at S310), and a search is performed in order to find other domains with the same email address in order to determine that those domains are related (e.g., to the same company).

At S340, hashes are generated for one or more resources of the computing infrastructure. The hashes may be generated based on icons, content, or other portions of the resources. As a non-limiting example, a hash of a website icon may be generated.

At S350, the hashes generated at S350 are compared to other hashes. As a non-limiting example, a hash of a website icon generated at S340 may be compared to hashes of other website icons to determine whether they match, for example, above a predetermined threshold.

At S360, textual similarities among identifiers are compared between one or more identifiers among the data identified at S310 and one or more other identifiers, for example identifiers indicated in one or more databases. The identifiers may be or may include, but are not limited to, names of network resources (e.g., Internet resources) such as, but not limited to, domain names, Internet Protocol (IP) address block identifiers, autonomous systems, combinations thereof, and the like. The autonomous systems are collections of connected IP routing prefixes under the control of one or more network operators on behalf of an administrative entity or domain that presents a common and clearly defined routing policy to the Internet.

In an embodiment, S360 may include performing a first query of one or more databases that store registered users or other assignees of network resources in order to identify such assignees based on, for example, an identifier such as a domain name or other network resource name included among the data identified at S310. In a further embodiment, S360 further includes performing a second query of one or more databases that store assignees of network resources in order to identify other network resource names associated with the assignees identified based on results of the first query. As a non-limiting example, an assignee of a first domain name is identified by performing a first query on a database using the first domain name, and one or more second domain names are identified by performing a second query on a database using an identifier of the assignee. This allows for enumerating all network resources assigned to the same assignee as the initial network resource (e.g., domain name).

FIG. 4 is a flowchart S230 illustrating a method for identifying integration points in a computing infrastructure according to an embodiment.

At S410, portions and components of the infrastructure are identified based on the results of the reconnaissance. Such portions of the infrastructure may include, but are not limited to, domains, sub-domains, portions thereof, and the like. The components may include, but are not limited to, network resources such as files or other data, devices or systems, applications or other programs, computing interfaces (e.g., application programming interfaces), operating systems, containers, combinations thereof, portions thereof, and the like.

In a further embodiment, the components include computing interfaces used to communicate between other components of those components. Such computing interfaces are relevant to potential integrations and may therefore aid in more accurately or more granularly identifying potential points of integration within the computing infrastructure. More specifically, such computing interfaces may be utilized to integrate with other components of the computing infrastructure and may therefore act as or with points of integration in order to enable integration. More specifically, the computing interfaces may be utilized to connect functions between infrastructure components in order to enable new functionality such that the computing interfaces may present or otherwise act as potential points of integration.

In yet a further embodiment, S410 may further include determining types of computing interfaces of the computing interfaces identified as infrastructure components. As a non-limiting example, such types of computing interfaces may include types of APIs such as public APIs, partner APIs, private APIs, composite APIs, and the like. Such public APIs are open and available for use by external entities and may, for example, expose components within the computing infrastructure to external components outside of the computing infrastructure. The partner APIs may be accessible only to certain authorized partner entities and may, for example, expose components within the computing infrastructure to external components outside of the computing infrastructure associated only with such partner entities. The internal APIs may be intended for use only within the computing infrastructure. The composite APIs may include combinations of APIs.

Different types of APIs may be utilized to identify whether certain connections realized via specific computing interfaces allow for realizing connections to other components of the computing infrastructure or to components outside of the computing infrastructure (i.e., components which are not part of the computing infrastructure). Additionally, when identifying misconfigurations or otherwise identifying potential vulnerabilities, the type of computing interface may be utilized to determine whether certain communications with other components are normal or otherwise secure.

In some embodiments, the portions of the infrastructure may further be defined with respect to stages in computing infrastructure development such as, but not limited to, production, staging, and the like. To this end, in subsequent steps, components may be further identified with respect to portions of the infrastructure at different stages in development. In this regard, it is noted that the layout of the computing infrastructure may change as development proceeds, and that identifying potential points of integration only using the final or most recent layout of the infrastructure may result in missing some potential points of integration. Accordingly, defining portions of the infrastructure with respect to different stages in development may allow for identifying points of integration which might otherwise be missed.

At S420, components of the computing infrastructure are correlated to portions of the infrastructure based on the results of the reconnaissance. More specifically, each component may be determined as belonging to a respective portion of the infrastructure, e.g., a respective domain or portion thereof.

At optional S430, traffic is monitored based on the components of the infrastructure correlated to the portions of the infrastructure at S420. The traffic monitoring may include, but is not limited to, identifying communications with and between the identified components. During the monitoring, additional components may be identified, for example, as previously unknown components which communicate with any of the components identified at S420 or otherwise with previously identified components. As noted above, the disclosed embodiments can be performed with a limited amount of traffic such as, but not limited to, a few hours' worth of traffic. Accordingly, monitoring traffic may allow for unearthing new potential connections or otherwise obtaining more information about existing connections in addition to the connections found based on reconnaissance results.

At S440, connections are established between the components of the computing infrastructure. The connections may be established based on, for example but not limited to, identifications of communications between respective components of the computing infrastructure, calls to computing interfaces which result in calling functions of other components of the computing infrastructure, and the like. In some embodiments, the connections are established based on the monitored traffic.

Non-limiting example connections include connections between computing interfaces and endpoints, connections between computing interfaces at different stages of infrastructure development (e.g., connecting an instance of a computing interface at one stage in development with an instance of the same computing interface at another stage in development), connections between components within portions of the computing infrastructure, connections between components between different portions of the computing infrastructure, combinations thereof, and the like.

At optional S450, the computing infrastructure is mapped based on the portions, components, and connections determined as discussed above with respect to S410 through S440. In an embodiment, the mapping at least includes components disposed within respective portions of the computing infrastructure identified as discussed above. The mapping may further include, but is not limited to, connections between those components, types of components (e.g., types of computing interfaces as discussed above), both, and the like.

At S460, potential points of integration are identified within the computing infrastructure. In some embodiments, the potential points of integration are identified based on the mapping. The potential points of integration may include, but are not limited to, components through which systems or applications may integrate with the computing infrastructure, for example, components which are, include, or are connected to computing interface components through which external components may communicate with components of the computing infrastructure. In other words, each integration point is a component through which the computing infrastructure is integrable, i.e., a component through which integrations are capable of being performed with respect to the computing infrastructure. To this end, each integration point is a component that is configured or otherwise adapted to connect to one or more services or systems deployed in the computing infrastructure.

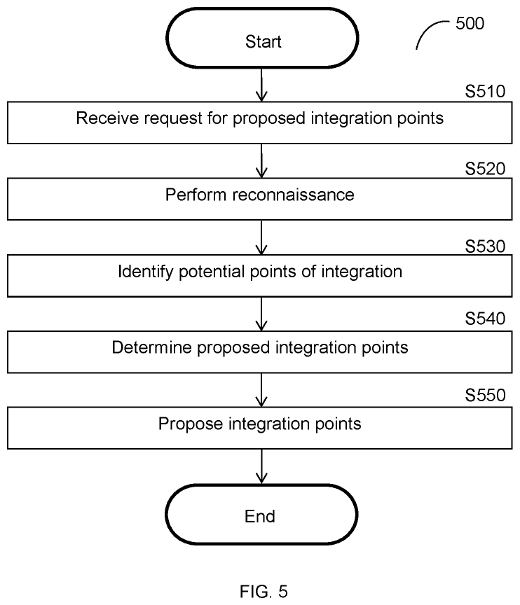

FIG. 5 is a flowchart 500 illustrating a method for proposing integration points for a computing infrastructure using reconnaissance techniques according to an embodiment. In an embodiment, the method is performed by the recon analyzer 130, FIG. 1.

At S510, a request for proposed integration points is received. The request may be received, for example, from the user device 120, FIG. 1. In an embodiment, the request includes one or more domain addresses, each of which identifies a system among the computing infrastructure to be secured. Such domain addresses may be, but are not limited to, Internet Protocol (IP) addresses, domain names, and the like.

At S520, reconnaissance is performed with respect to a computing infrastructure. In an embodiment, the reconnaissance is performed using at least some of the techniques described above with respect to FIG. 3. The reconnaissance may be utilized to identify components of the infrastructure and portions of the infrastructure in order to allow for correlating such components to such portions of the infrastructure.

At S530, potential points of integration are identified based on the reconnaissance. In an embodiment, S530 includes correlating between results of the reconnaissance and components of the computing infrastructure to identify one or more of those components as potential points of integration. In some embodiments, the potential points of integration may be determined at least partially as described above with respect to FIG. 3.

At S540, integration points are selected from among the potential points of integration and determined as proposed integration points. In an embodiment, S540 includes applying one or more integration point proposal determination rules which define criteria for selecting potential points of integration for proposal as proposed integration points. As a non-limiting example, such integration point proposal determination rules may include rules for determining proposed points of integration which are disposed in parts of the infrastructure where traffic integration is lacking, e.g., portions or sub-portions of the infrastructure where there are few or no integration points (e.g., below a threshold number of integration points).

Alternatively or collectively, such rules may define criteria for adding integration points in order to achieve a threshold number of integration points for a given domain, cloud provider, cloud platform, and the like. Moreover, in yet a further embodiment, the rules may be further defined with respect to the number of computing interfaces or other components which access certain domains, cloud providers, or cloud platforms. As a non-limiting example, if a high number (e.g., above a threshold number) of APIs in a computing infrastructure utilize a certain cloud platform corresponding to a respective domain, the proposed integration points may include a higher number of integration points for integrating to that cloud platform via that domain.

At S550, the proposed integration points determined at S540 are proposed. In an embodiment, S550 includes generating and sending a notification indicating the proposed integration points.

In a further embodiment, S550 further includes causing a display of a map (e.g., a map generated as described above with respect to S450, FIG. 4). The displayed map may illustrate the proposed integration points with respect to the computing infrastructure. To this end, in such an embodiment, S550 may include generating display elements and sending those display elements for display on, for example, a user device such as the user device 120, FIG. 1.

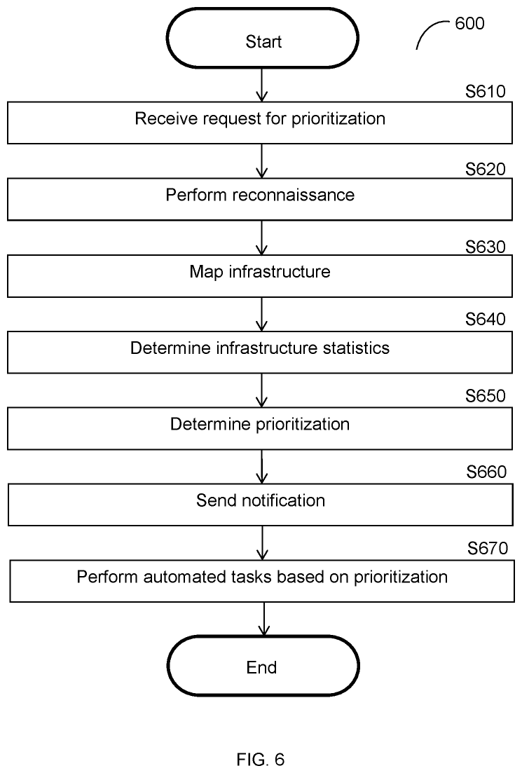

FIG. 6 is a flowchart 600 illustrating a method for prioritizing development for a computing infrastructure using reconnaissance techniques according to an embodiment. In an embodiment, the method is performed by the recon analyzer 130, FIG. 1.

At S610, a request for prioritization is received. The request may be received, for example, from the user device 120, FIG. 1. In an embodiment, the request includes one or more domain addresses, each of which identifies a system among the computing infrastructure to be secured. Such domain addresses may be, but are not limited to, Internet Protocol (IP) addresses, domain names, and the like.

In a further embodiment, the request includes a list of tasks to be prioritized. Such tasks may include, but are not limited to, research and development (R&D) tasks related to the development of the computing infrastructure. As noted above, the disclosed embodiments may be utilized in order to determine relative amounts of components within different portions of the infrastructure. Accordingly, R&D tasks or other tasks related to development of the infrastructure may be prioritized, for example, with respect to portions of the infrastructure having the highest number of components.

At S620, reconnaissance is performed with respect to a computing infrastructure. In an embodiment, the reconnaissance is performed using at least some of the techniques described above with respect to FIG. 3. The reconnaissance may be utilized to identify components of the infrastructure and portions of the infrastructure in order to allow for correlating such components to such portions of the infrastructure.

At S630, the computing infrastructure is mapped based on results of the reconnaissance. In an embodiment, the mapping at least includes components disposed within respective portions of the computing infrastructure identified as discussed above. The mapping may further include, but is not limited to, connections between those components, types of components (e.g., types of computing interfaces as discussed above), both, and the like. In a further embodiment, the mapping may be performed using at least a portion of the process described above with respect to FIG. 4.

At S640, infrastructure statistics are determined based on the mapping. The infrastructure statistics may include, but are not limited to, statistics indicating a relative number of components in different portions of the infrastructure. As a non-limiting example, it may be determined that 20% of components in the infrastructure are in a first domain, that 30% of components in the infrastructure are in a second domain, and that 50% of components in the infrastructure are in a third domain. As noted above, such statistics may be utilized to prioritize development of the infrastructure, e.g., by prioritizing portions of the infrastructure which have higher numbers or proportions of components.

In some implementations, the infrastructure statistics may be performed per-infrastructure, i.e., for different domains used within a computing infrastructure owned or operated by a given entity. In other implementations, the infrastructure statistics may be performed cross-infrastructure, e.g., for computing infrastructures owned or operated by different entities. For example, domain usage may be mapped in various computing infrastructures, for example using the techniques described herein, and components within each infrastructure may be identified as using resources from respective domains. The proportion of components using each domain across different computing infrastructures may therefore be utilized to determine cross-infrastructure statistics.

At S650, prioritization is determined based on the infrastructure statistics. The prioritization may, for example, include prioritizing tasks related to components in one portion of the infrastructure over components in other portions of the infrastructure, and may be determined based on relative amounts of components in each such portion. As a non-limiting example, when around 20% of the infrastructure uses components of a cloud provider of a first domain and around 5% of the infrastructure uses components of a cloud provider of a second domain, tasks related to components in the first domain may be prioritized over tasks related to components in the second domain.

Alternatively or in combination, prioritization may be based on relative numbers of integration points in different portions of the infrastructure, e.g., such that tasks to be performed in portions of the infrastructure having more potential integration points may be prioritized over tasks to be performed in portions of the infrastructure having fewer potential integration points. To this end, in some embodiments, S650 may include identifying potential points of integration in the infrastructure, for example using at least a portion of the process described above with respect to FIG. 4.

At optional S660, a notification may be sent. The notification may indicate, for example but not limited to, the determined prioritization. As a non-limiting example, a list of tasks may be organized by priority (e.g., from highest to lowest) and included in the notification. Such a notification may aid teams performing research and development in prioritizing development efforts.

At S670, one or more automated tasks are performed based on the prioritization. The automated tasks may include, but are not limited to, development tasks, tasks to secure the infrastructure, both, and the like. The tasks may be automatically performed based on the prioritization, for example, higher priority tasks are performed first, thereby improving infrastructure development and security.

In an embodiments, the tasks performed at S670 may further include creating integration points. To this end, S670 may include identifying potential points of integration and determining proposed points of integration, for example, using at least a portion of the process described above with respect to FIG. 5. As a non-limiting example, for portions of infrastructure using resources in a domain having a higher proportion of components across different computing infrastructures, more integration points may be created as compared to portions of infrastructure using resources in domains having lower proportions of components across the computing infrastructures.

It should be noted that the methods of FIGS. 2, 5, and 6 are depicted as separate flows for simplicity, but that the disclosed embodiments are not limited to only one of performing mitigation actions, proposing integration points, or prioritizing computing infrastructure development. At least some embodiments described herein may include any combination including at least one of performing mitigation actions, proposing integration points, and prioritizing computing infrastructure development, without departing from the scope of the disclosure. As a non-limiting example, results of reconnaissance and identification of integration points or mapping of a computing infrastructure may be utilized to propose integration points in the computing infrastructure and then to perform mitigation actions to secure the computing infrastructure.

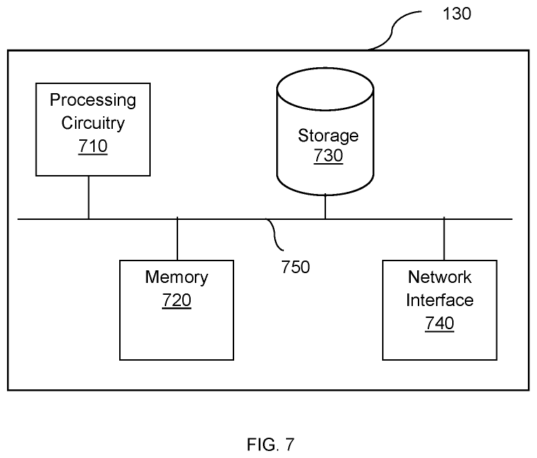

FIG. 7 is an example schematic diagram of an integration scout 130 according to an embodiment. The integration scout 130 includes a processing circuitry 710 coupled to a memory 720, a storage 730, and a network interface 740. In an embodiment, the components of the integration scout 130 may be communicatively connected via a bus 750.

The processing circuitry 710 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 720 may be volatile (e.g., random access memory, etc.), non-volatile (e.g., read only memory, flash memory, etc.), or a combination thereof.

In one configuration, software for implementing one or more embodiments disclosed herein may be stored in the storage 730. In another configuration, the memory 720 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 710, cause the processing circuitry 710 to perform the various processes described herein.

The storage 730 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 740 allows the integration scout 130 to communicate with, for example, the internal service 120, the admin device 150, and the like.

It should be understood that the embodiments described herein are not limited to the specific architecture illustrated in FIG. 5, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for securing a computing infrastructure, comprising:
performing reconnaissance with respect to a computing infrastructure in order to identify a plurality of portions of the computing infrastructure and a plurality of components of the computing infrastructure;
correlating the plurality of portions of the computing infrastructure with the plurality of components of the computing infrastructure;
identifying an integration point among the computing infrastructure based on the correlation, wherein the integration point is one of the plurality of components of the computing infrastructure through which the computing infrastructure is integrable; and
performing at least one mitigation action based on the identified integration point.

2. The method of claim 1, wherein performing the reconnaissance further comprises:
identifying at least one use of a matching certificate between resources of the computing infrastructure in a first domain and resources in a second domain, wherein the plurality of components is identified based on the identified at least one use of a matching certificate.

3. The method of claim 1, wherein performing the reconnaissance further comprises:
identifying common domain data between resources of a first domain of the computing infrastructure and resources of at least one second domain, wherein the plurality of components is identified based on the identified common domain data.

4. The method of claim 1, wherein performing the reconnaissance further comprises:
generating at least one first hash for at least one resource of the computing infrastructure; and
comparing the generated at least one first hash to a plurality of second hashes in order to identify at least one match between one of the at least one first hash and one of the plurality of second hashes, wherein the plurality of components is identified based on the identified at least one match.

5. The method of claim 1, further comprising:
mapping the plurality of components of the computing infrastructure to the plurality of portions of the computing infrastructure based on the correlation, wherein the integration point is identified based on the mapping.

6. The method of claim 1, further comprising:
monitoring traffic based on the correlation; and
establishing connections between the plurality of components of the computing infrastructure based on the monitored traffic.

7. The method of claim 1, further comprising:
applying at least one integration point vulnerability identification rule with respect to the identified integration point in order to identify a vulnerability with respect to the integration point, wherein each integration point identification vulnerability rule defines at least one circumstance with respect to a respective location in the computing infrastructure such that a vulnerability is detected for the integration point when circumstances of the integration point do not meet the at least one circumstances defined in the at least one integration point vulnerability identification rule.

8. The method of claim 7, wherein the plurality of components of the computing infrastructure include at least one computing interface, further comprising:
determining a type for each of the at least one computing interface, wherein the at least one integration point vulnerability identification rule is applied based on the determined type for each of the at least one computing interface.

9. The method of claim 1, wherein the reconnaissance is performed based on a domain address of a system within the computing infrastructure.

10. A non-transitory computer readable medium having stored thereon instructions for causing a processing circuitry to execute a process, the process comprising:
performing reconnaissance with respect to a computing infrastructure in order to identify a plurality of portions of the computing infrastructure and a plurality of components of the computing infrastructure;
correlating the plurality of portions of the computing infrastructure with the plurality of components of the computing infrastructure;
identifying an integration point among the computing infrastructure based on the correlation, wherein the integration point is one of the plurality of components of the computing infrastructure through which the computing infrastructure is integrable; and
performing at least one mitigation action based on the identified integration point.

11. A system for securing a computing infrastructure, comprising:
a processing circuitry; and
a memory, the memory containing instructions that, when executed by the processing circuitry, configure the system to:
perform reconnaissance with respect to a computing infrastructure in order to identify a plurality of portions of the computing infrastructure and a plurality of components of the computing infrastructure;
correlate the plurality of portions of the computing infrastructure with the plurality of components of the computing infrastructure;
identify an integration point among the computing infrastructure based on the correlation, wherein the integration point is one of the plurality of components of the computing infrastructure through which the computing infrastructure is integrable; and
perform at least one mitigation action based on the identified integration point.

12. The system of claim 11, wherein the system is further configured to:
identify at least one use of a matching certificate between resources of the computing infrastructure in a first domain and resources in a second domain, wherein the plurality of components is identified based on the identified at least one use of a matching certificate.

13. The system of claim 11, wherein the system is further configured to:
identify common domain data between resources of a first domain of the computing infrastructure and resources of at least one second domain, wherein the plurality of components is identified based on the identified common domain data.

14. The system of claim 11, wherein the system is further configured to:
generate at least one first hash for at least one resource of the computing infrastructure; and
compare the generated at least one first hash to a plurality of second hashes in order to identify at least one match between one of the at least one first hash and one of the plurality of second hashes, wherein the plurality of components is identified based on the identified at least one match.

15. The system of claim 11, wherein the system is further configured to:
map the plurality of components of the computing infrastructure to the plurality of portions of the computing infrastructure based on the correlation, wherein the integration point is identified based on the mapping.

16. The system of claim 11, wherein the system is further configured to:
monitor traffic based on the correlation; and
establish connections between the plurality of components of the computing infrastructure based on the monitored traffic.

17. The system of claim 11, wherein the system is further configured to:
apply at least one integration point vulnerability identification rule with respect to the identified integration point in order to identify a vulnerability with respect to the integration point, wherein each integration point identification vulnerability rule defines at least one circumstance with respect to a respective location in the computing infrastructure such that a vulnerability is detected for the integration point when circumstances of the integration point do not meet the at least one circumstances defined in the at least one integration point vulnerability identification rule.

18. The system of claim 17, wherein the plurality of components of the computing infrastructure include at least one computing interface, wherein the system is further configured to:
determine a type for each of the at least one computing interface, wherein the at least one integration point vulnerability identification rule is applied based on the determined type for each of the at least one computing interface.

19. The system of claim 11, wherein the reconnaissance is performed based on a domain address of a system within the computing infrastructure.
